(19) United States
(12) Patent Application Publication
(10) Pub. No.: US 2018/0090032 A1
(43) Pub. Date: Mar. 29, 2018

(54) CLEFT PALATE DIAGNOSTIC TRAINING SET

(71) Applicant: Michael Mars, London (GB)

(72) Inventor: Michael Mars, London (GB)

(21) Appl. No.: 15/563,621

(22) PCT Filed: Mar. 30, 2016
(86) PCT No.: PCT/GB2016/050896

§ 371 Date: Oct. 2, 2017

(30) Foreign Application Priority Data
Mar. 31, 2015 (GB) 1505589.0

(51) Int. Cl. G09B 23/30

(52) U.S. Cl. CPC G09B 23/30; A61C 9/004

(57) ABSTRACT

A cleft palate diagnostic training set comprises silicone models of palates including a plurality of models which represent cleft palates and a plurality of model which represent normal, non-cleft palates.

The present invention relates to a cleft palate diagnostic training set.

The palate is the roof of the mouth which separates the oral cavity from the nasal cavity. It is composed of two portions, namely the anterior bony hard palate, and the posterior fleshy soft palate.

The palate is formed during early pregnancy when the left and right sides of the face develop individually and subsequently join together. The joining process begins at the front of the mouth and progresses backwards to the rear of the mouth. If the two parts fail to join together fully this can result in a cleft remaining in the palate.

Depending on the degree to which the two parts of the face join, clefts that occur in the oral-facial region can involve the upper lip, the roof of the mouth (hard palate), or the soft tissue in the back of the mouth (soft palate). Those suffering from a cleft typically encounter problems feeding, with speech, and may be prone to frequent ear infections that can lead to hearing loss, all of which may lead to psychological problems. Dental problems may also occur.

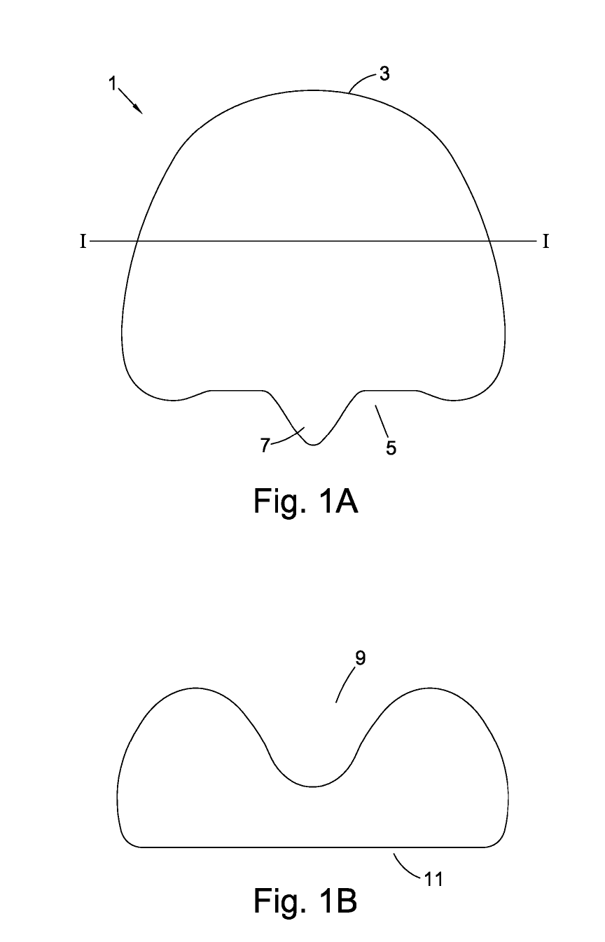

FIG. 1A is a representation of a normal palate 1 when it is viewed from below, with the mouth being located at the top 3 of the Figure and the throat at the bottom 5. The uvula 7 is shown projecting from the bottom 5 of the palate 1. FIG. 1B is a cross section along line I-I of FIG. 1A, where the nasal cavity 9 is above the palate 1 and the oral cavity 11 is below it.

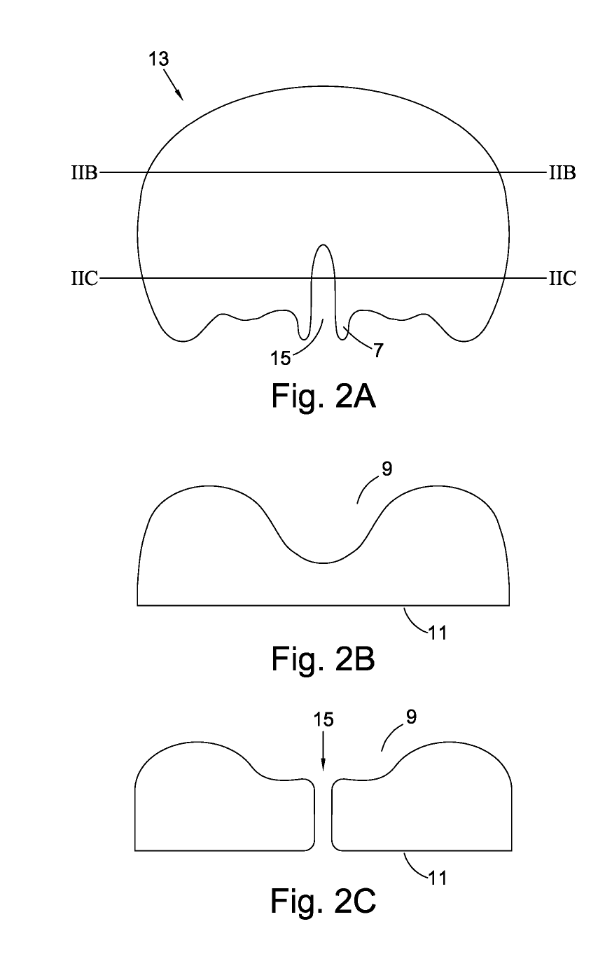

FIG. 2A is a representation of a cleft soft palate 13, FIG. 2B is a cross section along line IIB-IIB of FIG. 2A and FIG. 2C is a cross section along line IIC-IIC of FIG. 2A. As is apparent from FIGS. 2A and 2C, the cleft 15 is formed in the soft palate where the left and right sides of the face have not fully joined during pregnancy, to split the uvula 7. The cleft 15 therefore links the nasal 9 and oral 11 cavities further forward than in the normal palate 1 shown in FIGS. 1A and 1B.

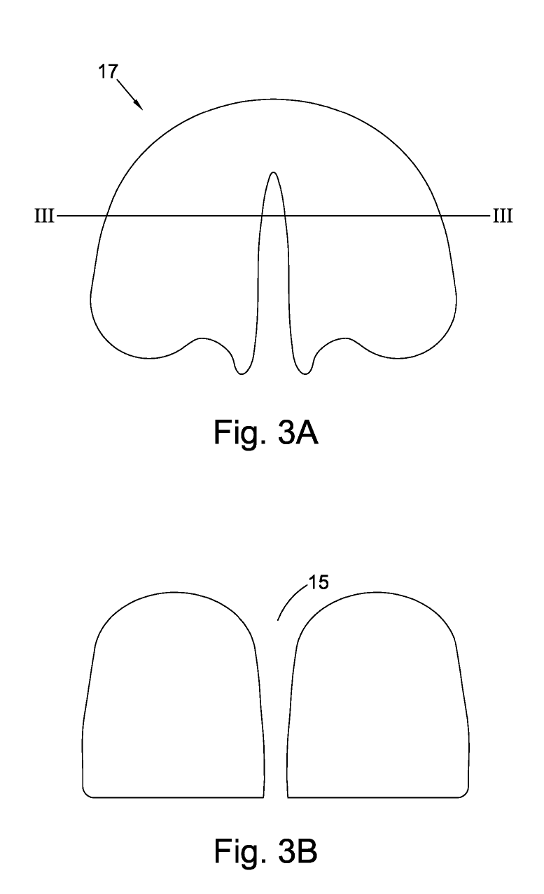

FIG. 3A is a representation of a cleft hard and soft palate 17 and FIG. 3B is a cross section along line of FIG. 3A. In this condition the cleft 15 extends beyond the soft palate into the hard palate towards the front of the oral cavity.

Once a child has been diagnosed as having a cleft palate, treatments including surgery normally begin within the first year of life. The reason for this early intervention is that if corrective surgery is required then this should be performed as early as possible in order to eliminate the potential health risks outlined above. However, in order to be able to treat sufferers it is first necessary to diagnose this condition. Since a cleft palate will present itself at birth it is standard practice for a paediatric doctor to check for this condition prior to discharging a baby from a maternity unit of a hospital. If a cleft palate is not diagnosed at this early stage of the child's development then it may only be detected once the child presents difficulties in speech or feeding, which may then necessitate more complex surgical interventions.

Best practice is to visually inspect the palate. Visual inspection requires the doctor to forcibly open the baby's mouth, depress the tongue using a tongue depressor and illuminate the palate, typically with a torch. However, in order to avoid causing distress to the baby, doctors often use palpation, i.e., the doctor using his/her fingers to examine the shape and texture of the palate. Due to the subtle nature of some mild cases of cleft palate, particularly where only the soft palate is cleft, the digital palpation method often leads to failed diagnosis of cleft palate.

It is an aim of the present invention to provide a training tool to improve the diagnosis of cleft palate.

According to a first aspect of the invention, there is provided a cleft palate diagnostic training set comprising a plurality of silicone models of palates including at least one model which represents a cleft palate.

The training set may include at least one model which represents a normal palate. The training set may include a plurality of models which represent cleft palates. The training set may include a plurality of models which represent normal palates. The training set may include a plurality of models which represent cleft palates and a plurality of models which represent normal palates.

Each model may include a palate model portion and a base portion surrounding the palate model portion.

Each model may include a palate model portion which has the shape of a baby's palate.

The models have a Shore A hardness within the range of 12 to 30, optionally within the range of 13 to 25, optionally within the range of 14 to 20, optionally within the range of 15 to 18 and optionally having a Shore A hardness of 16.

The invention will now be described by way of example with reference to the drawings, in which:

FIG. 1A is a representation of a normal palate when viewed from below;

FIG. 1B is a cross section along line I-I of FIG. 1A;

FIG. 2A is a representation of a cleft soft palate;

FIG. 2B is a cross section along line IIB-IIB of FIG. 2A;

FIG. 2C is a cross section along line IIC-IIC of FIG. 2A;

FIG. 3A is a representation of a cleft hard and soft palate;

FIG. 3B is a cross section along line of FIG. 3A; and

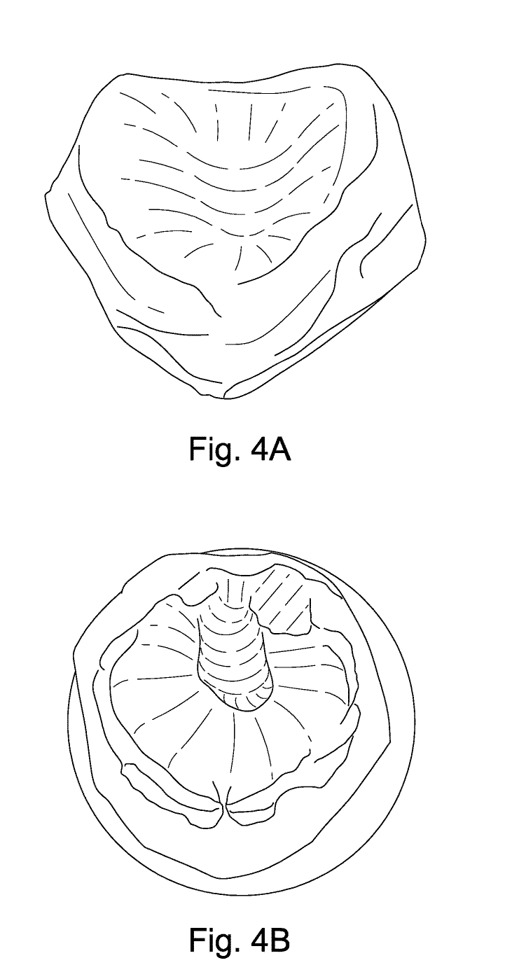

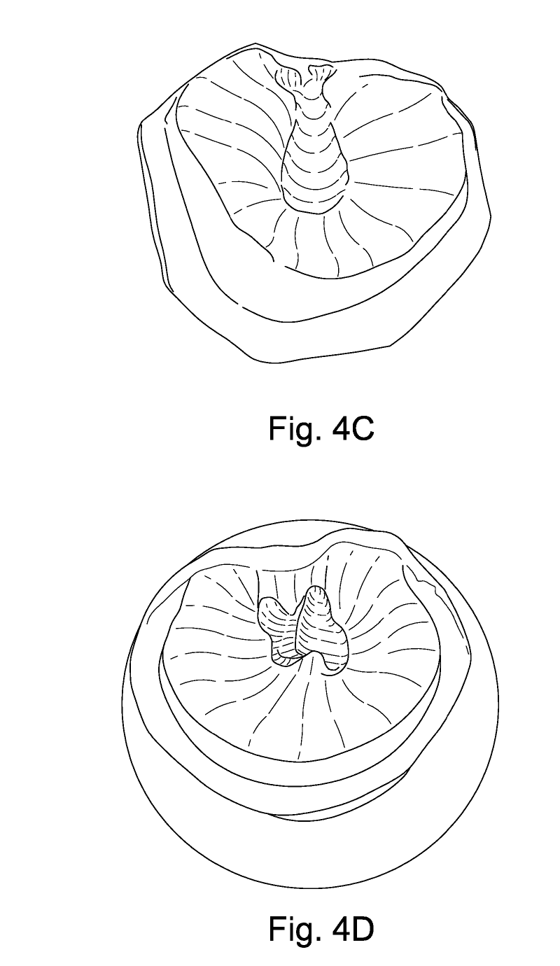

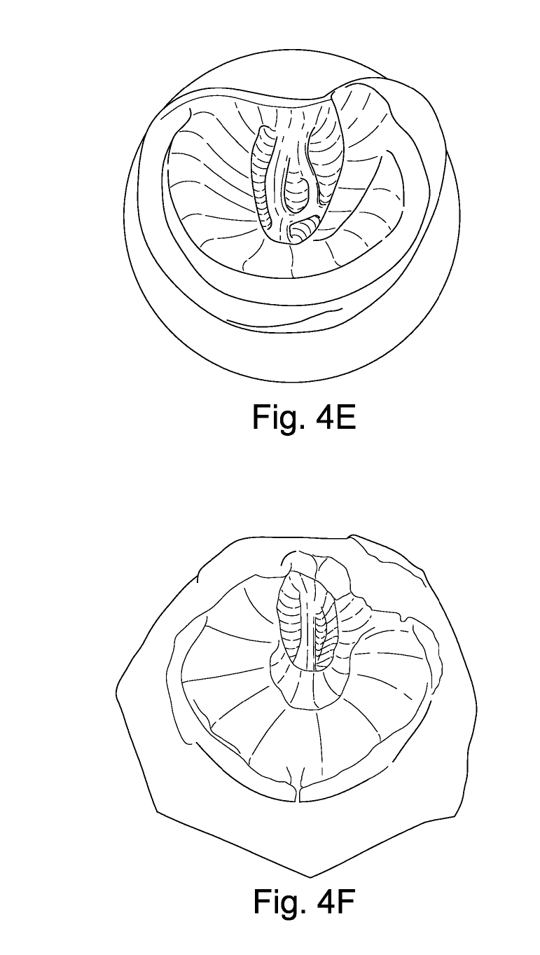

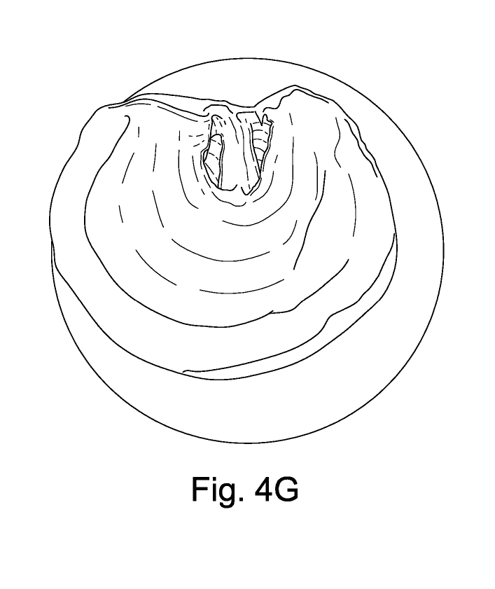

FIGS. 4A-G are models of palates forming part of the diagnostic training set according to an embodiment of the invention.

As described above, FIGS. 1-3 are representations of babies' palates, of which FIGS. 2-3 are representations of palates which are cleft to differing degrees. In order to improve paediatric doctors' competency in diagnosing cleft palate by palpation the present invention provides a training set for diagnosing cleft palate. The diagnostic training set comprises a plurality of silicone models of palates including at least one model which represents a cleft palate. During training of doctors and in particular paediatric doctors, the present invention allows the process of familiarising medical professionals about the physiological signs of cleft palate to include palpation of the training set, in order to hone the doctors' diagnostic skills.

The training set includes at least two models of palates including a normal (non-cleft) palate and a cleft palate. The training set may include more than two palates, including at least two normal (non-cleft) palates or at least two cleft palates. Further, the training set may include at least two normal (non-cleft) palates and at least two cleft palates.

In this embodiment the models are made from a silicone. An advantage of making the models out of silicone is that they can be moulded easily and the models themselves have the same softness and malleability as a real palate, thereby making them as similar as possible to texture of the palate of a baby.

The models are made by first making hard models of babies' palates, typically using gypsum plaster (plaster of Paris) from a number of babies, some of whom have cleft palates. Existing models are available to medical professionals practicing in this area. From these plaster models a mould (a negative) is made for producing the models forming part of the training set. Once these negatives are obtained the models forming part of the training set are formed by pouring silicone. The silicone typically comes in the form of a liquid which is poured into the mould and left to cure. An example of commercially available silicone is Tiranti T20 Silicone Mould Rubber. A catalyst such as Tiranti T5 Fast Catalyst is used to assist with the curing process. Once the silicone is fully cured the model can be removed from the mould. The models produced by this process have a Shore A hardness of 16.

FIGS. 4A-G are models of palates forming part of the diagnostic training set according to an embodiment of the invention. In each of these figures, the gums are shown at the bottom of the figure and the throat is at the top. Further, in addition to the models being a mould of the babies' palates, each model includes a base portion which extends around the model portion of the babies' palate.

In these figures, FIGS. 4A-4C are normal (non-cleft) palates and FIGS. 4D-4G are models of cleft palates.

When considering FIGS. 4A-4C the following observations can be made. FIG. 4A shows a palate with a gently curved roof. FIG. 4B shows a palate which has steeper edges in the centre portion as the roof rises to its pinnacle and FIG. 4C shows a palate with yet steeper walls in its centre portion but which still constitutes a normal palate.

In contrast, FIGS. 4D-4G show cleft palates. FIG. 4D shows a cleft soft palate. FIG. 4E shows a cleft hard and soft palate, where the cleft extends from the rear of the palate to near the front of the palate, to the region of the gums. In FIG. 4F only the soft palate is cleft and it can be seen that the cleft extends significantly upwards through the roof of the mouth, joining with the nasal cavity. Finally, FIG. 4G shows a further cleft soft palate but where the roof of the mouth is shallow and where the cleft itself has steep and narrow walls.

It can be observed that some of the normal and cleft palates are similar. Although visual inspection can distinguish the two, digital palpation may not be as effective. For example, by comparing FIGS. 4C and 4F it can be seen in both cases that the sides of the roof of the mouth become steeper towards the central axis of the mouth, however the cleft at the rear of the palate in FIG. 4F may be missed using digital palpation due to its similar shape to the roof of FIG. 4C. Hence, it can be seen by comparing these two models that since both models are made of resilient or malleable material, when a finger is pushed against these two models the training doctor will be able to push away the steep sides of the palate until their fingers reach the pinnacle of the palate, and in pushing aside the walls of the models the doctor will be able to feel the presence of the cleft in FIG. 4F and the smooth roof in FIG. 4C.

Similarly, it can been seen that the model of the palate in FIG. 4G has a gently curved roof with only a small cleft at its rear. A doctor palpating such a palate may miss the cleft due to its small size. However, since the model is resilient when the doctor pushes his/her finger against the centre of the roof of the palate, the edges of the cleft will deform, thereby allowing the doctor to push his/her finger into the cleft to detect it.

It is intended that these palates will be used to train medical professionals by presenting each model to the professional in its normal orientation, i.e., with the gum part at the front and pointing downwards, so that the shape of the palate cannot be viewed by the professional. Only once the professional has attempted to diagnose the normality of the palate should the professional be allowed to visibly inspect each model of the palate. This process can then be repeated until the medical professional has familiarised themselves sufficiently with the different ways in which this condition may present itself.

Various modifications will be apparent to those in the art and it is desired to include all such modifications as fall within the scope of the accompanying claims.

Although in the embodiment described above the models in the training set are made from silicone, other materials having similar mechanical properties may be used. For example, the models may be made from rubber, plastic, other polymers or other resilient or malleable materials.

In the embodiment described above the models are made from silicone having a Shore A hardness of 16. In other embodiments the models may have a Shore A hardness other than 16. For example the Shore A hardness of the models may be in the range of 12 to 30, preferably within the range of 13 to 25, preferably within the range of 14 to 20 and further preferably within the range of 15 to 18.

1. A cleft palate diagnostic training set comprising a plurality of silicone models of palates including at least one model which represents a cleft palate.

2. A training set as claimed in claim 1, further including at least one model which represents a normal palate.

3. A training set as claimed in claim 1, including a plurality of models which represent cleft palates.

4. A training set as claimed in claim 1, including a plurality of models which represent normal palates.

5. A training set as claimed in claim 1, including a plurality of models which represent cleft palates and a plurality of models which represent normal palates.

6. A training set as claimed in claim 1, wherein each model includes a palate model portion and a base portion surrounding the palate model portion.

7. A training set as claimed in claim 1, wherein each model includes a palate model portion which has the shape of a baby's palate.

8. A training set as claimed in claim 1, wherein the models have a Shore A hardness within the range of 12 to 30.

9. A training set as claimed in 8, wherein the models have a Shore A hardness within the range of 13 to 25.

10. A training set as claimed in 9, wherein the models have a Shore A hardness within the range of 14 to 20.

11. A training set as claimed in 10, wherein the models have a Shore A hardness within the range of 15 to 18.

12. A training set as claimed in 11, wherein the models have a Shore A hardness of 16.
